(19) United States
(12) Patent Application Publication
(10) Pub. No.: US 2021/0400069 A1
(43) Pub. Date: Dec. 23, 2021

(54) INFORMATION PROCESSING APPARATUS

(71) Applicant: NEC Corporation, Minato-ku, Tokyo (JP)

(72) Inventors: Shohei MITANI, Tokyo (JP); Satoru YAMANO, Tokyo (JP)

(73) Assignee: NEC Corporation, Minato-ku, Tokyo (JP)

(21) Appl. No.: 17/285,678

(22) PCT Filed: Oct. 29, 2018
(86) PCT No.: PCT/JP2018/040120

§ 371 Date: Apr. 15, 2021

(51) Int. Cl. H04L 29/06; H04L 12/24; H04L 12/26

(52) U.S. Cl. CPC H04L 63/1425; H04L 43/08; H04L 41/147

(57) ABSTRACT

An information processing apparatus according to the present invention includes a generation unit configured to generate the allowable range of a possible value of data measured from a target system based on a model for predicting the data measured in the target system and the data having been measured from the target system; and a detection unit configured to detect the state of the target system based on the data measured from the target system and the allowable range.

### TECHNICAL FIELD

The present invention relates to an information processing apparatus that monitors the state of a target system, an information processing method, and a program.

### BACKGROUND ART

In recent years, an information processing system is used in various fields, and there is a need to quickly respond to anomalous states such as a system failure and an attack from the outside. For this, it is important to monitor the state of an information processing system. For example, in an OT (Operational Technology) system, which is a system using an operation control technique for monitoring and controlling the physical state of a system, an anomaly in a target system is detected by monitoring physical process data and network traffic data.

Examples of a method for detecting an anomaly in a target system are methods disclosed in Patent Document 1 and Patent Document 2. Patent Document 1 describes a method of preparing a white list that defines system information allowed in accordance with the state of a target system beforehand. According to this method, an attack on a target system is detected by comparing actually communicated communication data with the white list. Patent Document 2 describes that the degree of anomaly between the header pattern of a packet flowing on a network and the data pattern of the packet is learned in advance and a threshold value for determining an anomaly is set.

Based on the degree of anomaly between the header pattern and the data pattern of a received packet and the set threshold value, an anomaly in the packet is determined. Patent Document 2 also describes changing the above threshold value.

### Patent Document 1: Japanese Translation of PCT International Application Publication WO2018/134939

### Patent Document 2: Japanese Unexamined Patent Application Publication JP-A 2011-135131

However, according to the techniques disclosed in Patent Documents 1 and 2 described above, a criterion for detecting an anomaly is constant and it is therefore difficult to precisely detect an anomaly in a target system whose state varies from moment to moment. For example, the white list set for each state is constant in Patent Document 1 and, even if the threshold value is changed, the changed threshold value is constant in Patent Document 2. As seen from the above, the technique of detecting an anomaly based on a constant determination criterion causes a problem that it is impossible to precisely detect an anomalous state in a target system in accordance with a situation. Then, such a problem arises not only in the case of detecting an anomalous state in a target system, but also in a case where there is a need to detect every state such as the normal state, stopped state, high operation state, low operation state, or maintenance state of a target system. As a result, there arises a problem that it is impossible to precisely detect every state of a target system in accordance with a situation.

### SUMMARY

Accordingly, an object of the present invention is to provide an information processing apparatus which can solve the abovementioned problem that it is impossible to precisely detect the state of a target system.

An information processing apparatus as an aspect of the present invention includes: a generation unit configured to generate an allowable range of a possible value of data measured from a target system based on a model for predicting the data measured in the target system and the data having been measured from the target system; and a detection unit configured to detect a state of the target system based on the data measured from the target system and the allowable range.

Further, a computer program as another aspect of the present invention includes instructions for causing an information processing apparatus to realize: a generation unit configured to generate an allowable range of a possible value of data measured from a target system based on a model for predicting the data measured in the target system and the data having been measured from the target system; and a detection unit configured to detect a state of the target system based on the data measured from the target system and the allowable range.

Further, an information processing method as another aspect of the present invention includes: generating an allowable range of a possible value of data measured from a target system based on a model for predicting the data measured in the target system and the data having been measured from the target system; and detecting a state of the target system based on the data measured from the target system and the allowable range.

With the configurations as described above, the present invention enables precise detection of the state of a target system.

### BRIEF DESCRIPTION OF DRAWINGS

FIG. 1 is a block diagram showing a configuration of an information processing apparatus in a first example embodiment of the present invention;

FIG. 2 is a view showing a state of processing by each component of the information processing apparatus disclosed in FIG. 1;

FIG. 3 is a view showing a state of processing by a traffic data learning unit of the information processing apparatus disclosed in FIG. 1;

FIG. 4 is a view showing a state of processing by a process data learning unit of the information processing apparatus disclosed in FIG. 1;

FIG. 5 is a view showing a state of processing by a traffic data prediction unit of the information processing apparatus disclosed in FIG. 1;

FIG. 6 is a view showing a state of processing by a process data prediction unit of the information processing apparatus disclosed in FIG. 1;

FIG. 7 is a view showing a state when the traffic data prediction unit and the process data prediction unit of the information processing apparatus disclosed in FIG. 1 generate the allowance range of data;

FIG. 8 is a view showing an example of data measured from a target system disclosed in FIG. 1;

FIG. 9 is a view showing an example of execution of an anomaly detection process on the target system disclosed in FIG. 1;

FIG. 10 is a view showing an example of execution of an anomaly detection process on the target system disclosed in FIG. 1;

FIG. 11 is a flowchart showing an operation at the time of learning by the information processing apparatus disclosed in FIG. 1;

FIG. 12 is a flowchart showing an operation at the time of detection by the information processing apparatus disclosed in FIG. 1; and

FIG. 13 is a block diagram showing a configuration of an information processing apparatus in a second example embodiment of the present invention.

### EXAMPLE EMBODIMENTS

### First Example Embodiment

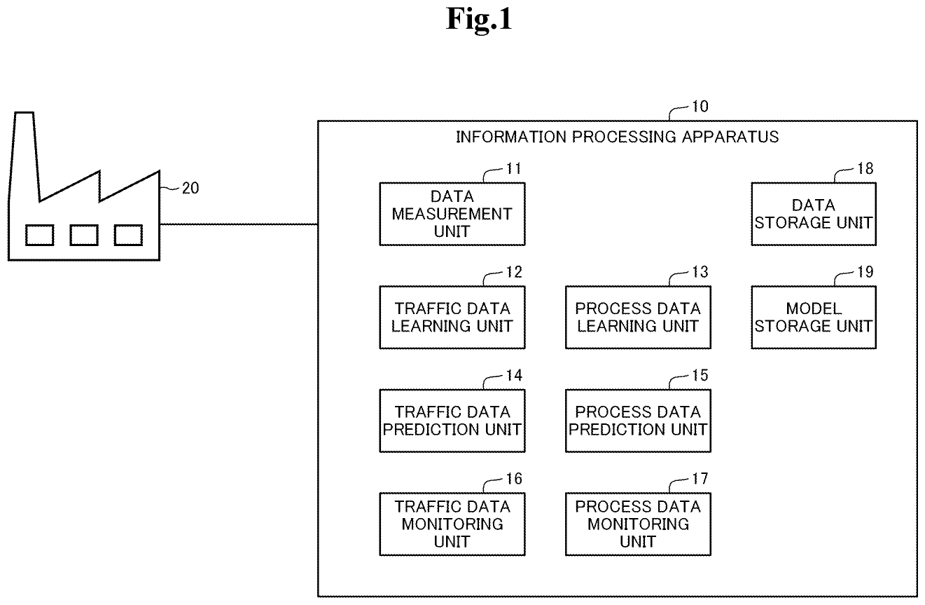

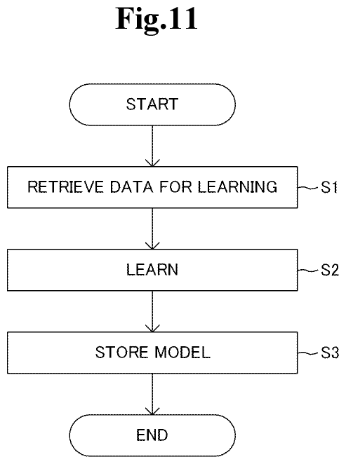

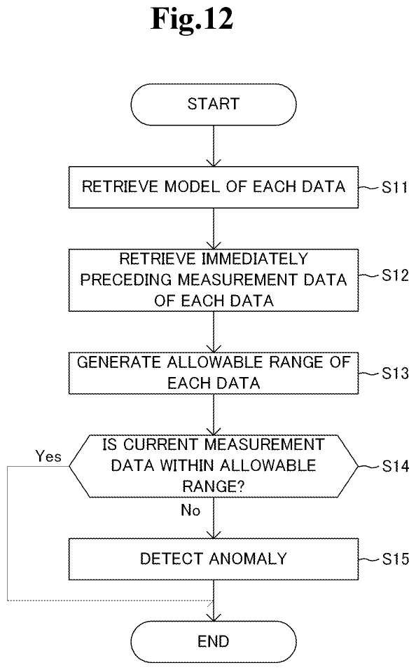

A first example embodiment of the present invention will be described with reference to FIGS. 1 to 11. FIGS. 1 to 10 are views for describing a configuration of an information processing apparatus, and FIGS. 11 to 12 are views for describing an operation of the information processing apparatus. In the following, the configuration and the operation of the present invention will be described together.

An information processing apparatus 10 according to the present invention is connected to a target system 20 such as a plant, and used for monitoring the state of the target system 20. The target system 20 sends out, for example, traffic data, which are a plurality of kinds of network data, and process data, which are a plurality of kinds of physical data. To be specific, traffic data are packet data such as a control packet and a monitoring packet, and measurement values thereof are an interpacket gap, a packet frequency, a packet generation time, and so on. Process data are physical quantities such as a temperature and an air-conditioning operation rate output from a sensor and a device installed in the target system 20, and measurement values thereof are a continuous value, a discrete value, a derivative, an integral, and so on.

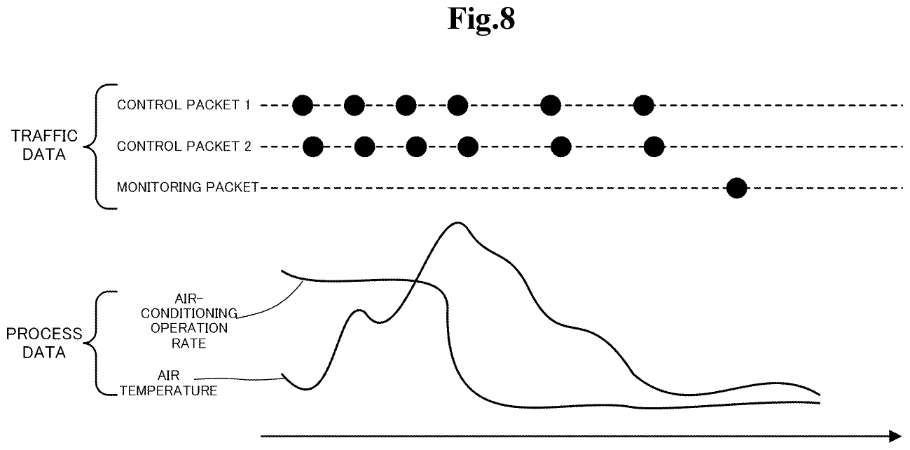

An example of data sent out and measured from the target system 20 is shown in FIG. 8. As shown in FIG. 8, from the target system 20, a control packet 1, a control packet 2, and a monitoring packet are measured as traffic data, and an air temperature and an air-conditioning operation rate are measured as process data. Data measured from the target system 20 is not limited to necessarily include traffic data and process data. For example, the target system 20 may be a system from which at least one kind of data is measured.

The information processing apparatus 10 is composed of one information processing apparatus or a plurality of information processing apparatuses each including an arithmetic logic unit and a memory unit. The information processing apparatus 10 includes, as shown in FIG. 1, a data measurement unit 11, a traffic data learning unit 12, a process data learning unit 13, a traffic data prediction unit 14, a process data prediction unit 15, a traffic data monitoring unit 16, and a process data monitoring unit 17 that are structured by execution of a program by the arithmetic logic unit. The information processing apparatus 10 also includes a data storage unit 18 and a model storage unit 19 that are formed in the memory unit. In the following, the respective components and operations thereof will be described in detail.

The data measurement unit 11 acquires data measured from the target system 20, stores the data into the data storage unit 18, and also passes the data to the traffic data monitoring unit 16 and the process data monitoring unit 17. As described above, data acquired by the data measurement unit 11 are a plurality of kinds of traffic data and a plurality of kinds of process data as shown in FIG. 8.

The traffic data learning unit 12 and the process data learning unit 13 (a model generation unit) first input past data for learning measured from the target system 20 into the learning units (step S1 of FIG. 11). Then, the traffic data learning unit 12 and the process data learning unit 13 generate a model for predicting data measured at normal time from the target system 20, for each kind of data (step S2 of FIG. 11). Then, the traffic data learning unit 12 and the process data learning unit 13 store the model generated for each kind of data into the model storage unit 19 (step S3 of FIG. 11).

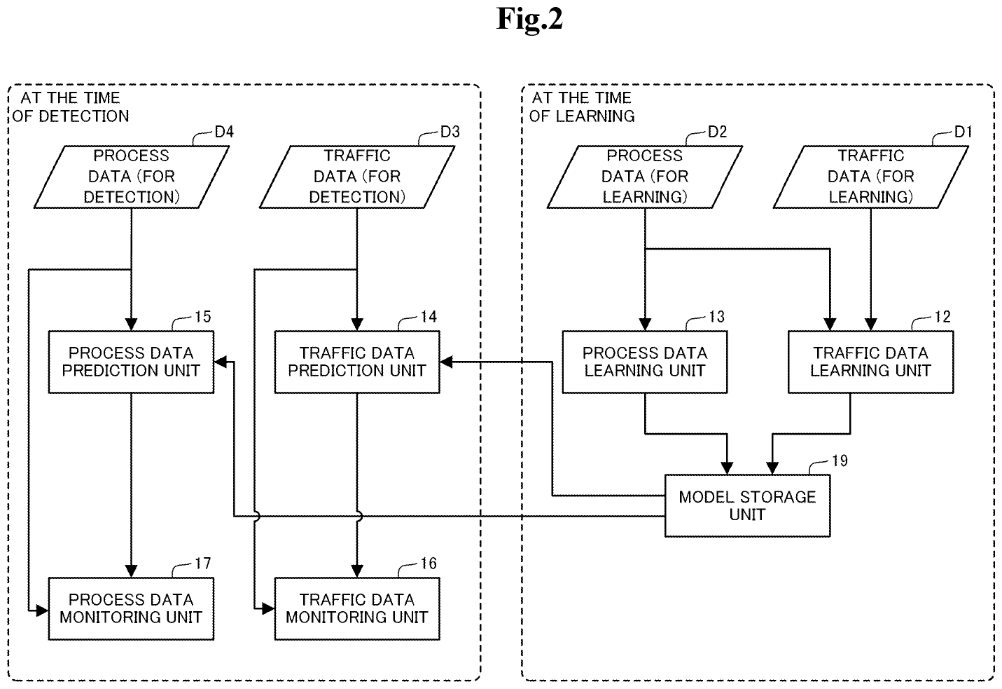

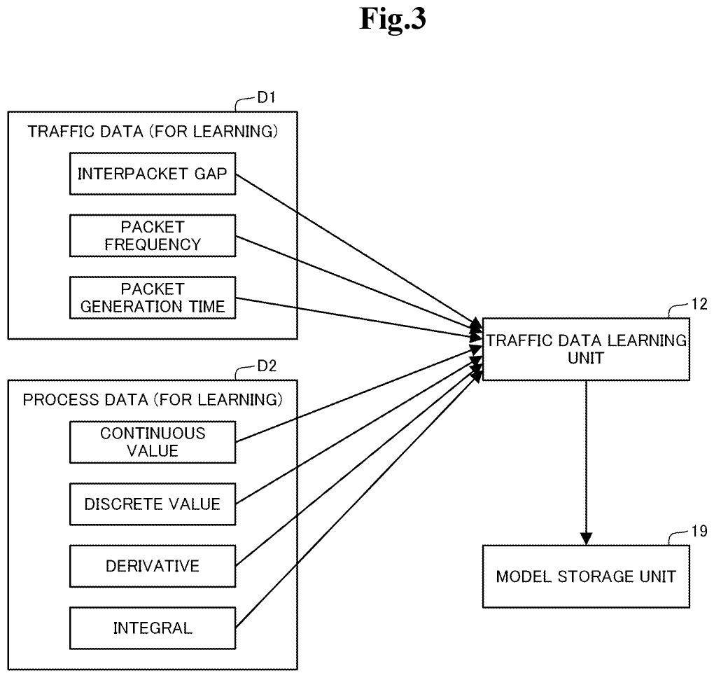

To be specific, as shown in the right view of FIG. 2 and FIG. 3, the traffic data learning unit 12 first inputs the traffic data D1 for learning and process data D2 for learning stored in the data storage unit 18 into the learning unit. At this time, the traffic data D1 for learning and the process data D2 for learning are data measured prior to the present moment (a predetermined moment) at which the target system 20 is monitored. For example, the interpacket gap, packet frequency, and packet generation time of every kind of packet are input as the traffic data D1, and the continuous value, discrete value, derivative, and integral of every kind of physical quantity are input as the process data D2.

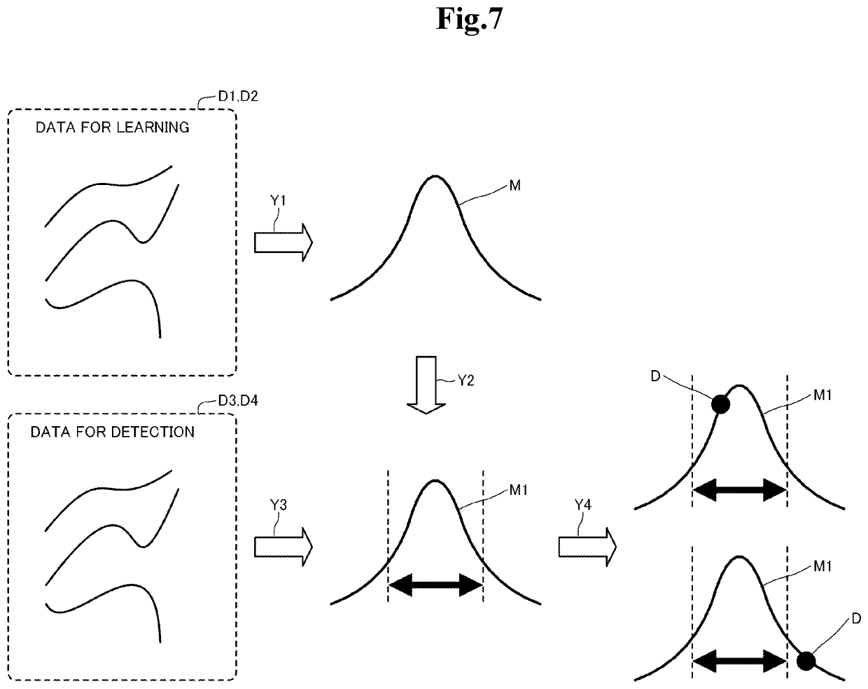

Then, the traffic data learning unit 12 performs learning based on the input traffic data D1 and process data D2, and generates a model M for predicting each value such as the interpacket gap, packet frequency, and packet generation time of every kind of packet in normal time as shown by an arrow Y1 of FIG. 7. After that, the traffic data learning unit 12 stores the generated model M into the model storage unit 19. In FIG. 7, the predictive distribution, that is, probability distribution of possible values of a value to be measured later is generated as the model M as an example, but any model may be generated. A method for learning may be any method; for example, linear regression, stochastic process regression, perceptron, support vector machine, deep neural network, decision tree, and rule extraction. The traffic data learning unit 12 may perform learning based on only the traffic data D1 for learning to generate the model M. In the learning described above, learning is performed only by inputting past data at normal time, and either a label indicating a state such as normal/abnormal or anomalous data is not required. That is to say, in the learning described above, so-called unsupervised learning is performed.

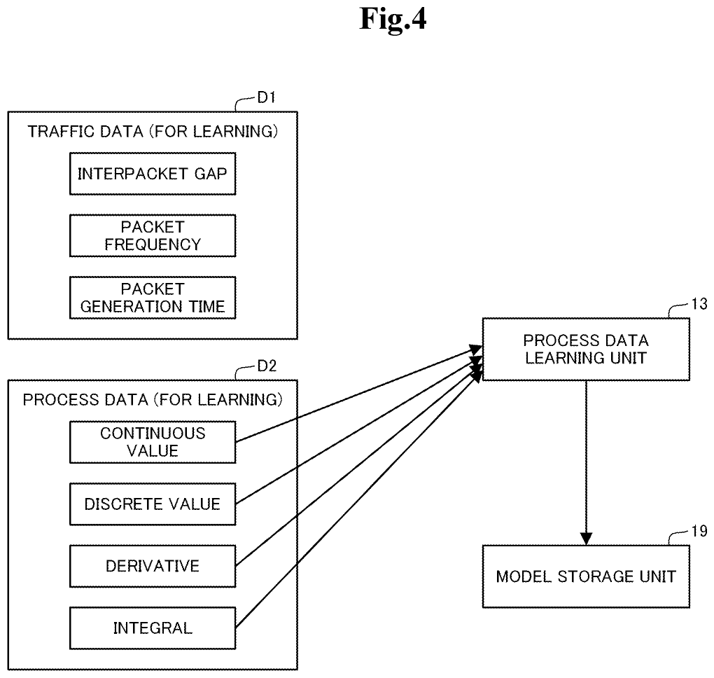

As an example, as shown in the right view of FIG. 2 and FIG. 4, the process data learning unit 13 first inputs the process data D2 for learning stored in the data storage unit 18 into the learning unit. At this time, the process data D2 for learning are data measured prior to the present moment (a predetermined moment) at which the target system 20 is monitored. For example, the continuous value, discrete value, derivative, and integral of every kind of physical quantity are input as the process data D2.

Then, as with the traffic data learning unit 12 described above, the process data learning unit 13 performs learning based on the input process data D2, and generates a model M for predicting each value such as the continuous value of every kind of process data in normal time. After that, the process data learning unit 13 stores the generated model M into the model storage unit 19. The process data learning unit 13 may input, in addition to the process data D2 for learning, the traffic data D1 for learning into the learning unit, and generate the model M based on these data. Moreover, the process data learning unit 13 may perform learning by any learning method and may generate any model as with the traffic data learning unit 12 described above.

The traffic data prediction unit 14 and the process data prediction unit 15 (a generation unit) operate at the time of monitoring the target system 20, and generate allowable range data representing the allowable range of a possible value of data measured at the present moment at which monitoring is performed. At this time, the traffic data prediction unit 14 and the process data prediction unit 15 generate allowable range data based on the generated model M and data having been measured from the target system 20 for each kind of data.

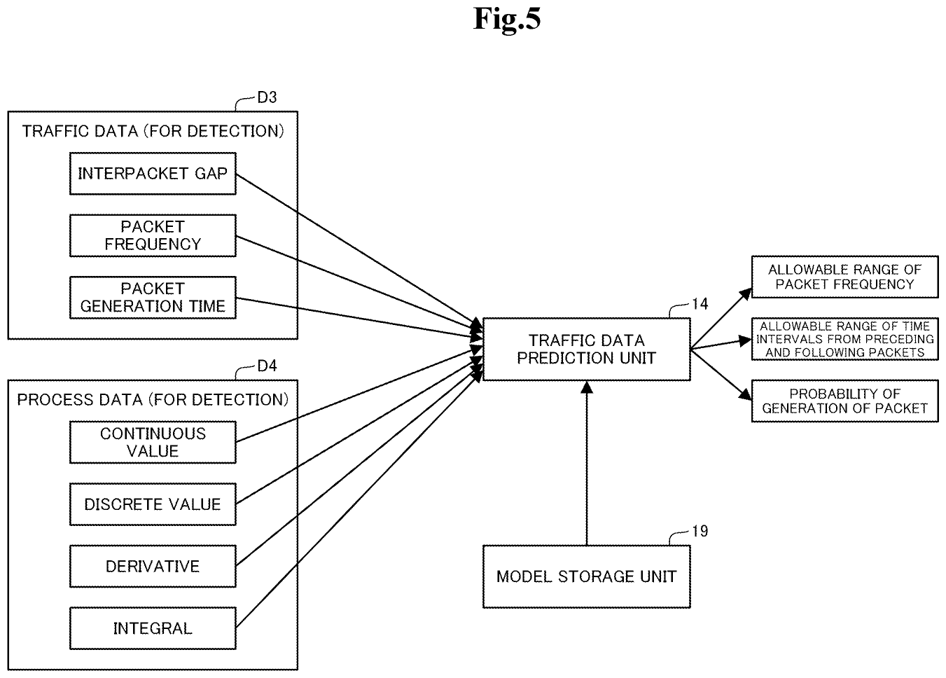

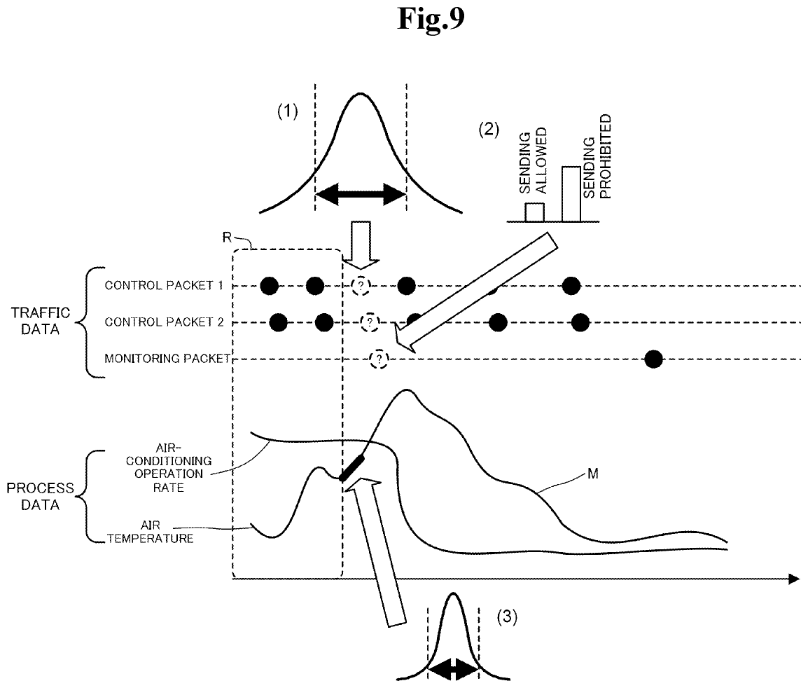

To be specific, the traffic data prediction unit 14 first retrieves the model M from the model storage unit 19 as shown in the left view of FIG. 2 and FIG. 5 (step S11 of FIG. 12). In addition to this, the traffic data prediction unit 14 inputs traffic data D3 for detection and process data D4 for detection stored in the data storage unit 18 into the model. At this time, the traffic data prediction unit 14 inputs, as the traffic data D3 for detection and the process data D4 for detection, data measured in a predetermined range time immediately before the present moment (a given time) at which the target system 20 is monitored (see reference symbol R of FIG. 9) from among data measured prior to the present moment (step S12 of FIG. 12). For example, the traffic data prediction unit 14 inputs the interpacket gap, packet frequency, and packet generation time of every kind of packet as the traffic data D1, and inputs the continuous value, discrete value, derivative, and integral of every kind of measurement value as the process data D2.

Then, the traffic data prediction unit 14 generates allowable range data M1 representing an allowable range that each value such as the interpacket gap, packet frequency, or packet generation time of every kind of packet can take, based on the model M and the traffic data D3 and process data D4 for detection, as indicated by an arrow Y2 and an arrow Y3 of FIG. 7 (step S13 of FIG. 12). For example, the traffic data prediction unit 14 generates a probability distribution according to the immediately preceding traffic data D3 and process data D4 from the existing model M. Then, the traffic data prediction unit 14 generates the allowable range data M1 that specifies a value range allowed to be measured at the present moment, such as a range defined by a black arrow (a range defined by dotted lines) shown in the allowable range data M1 of FIG. 7, on the entire probability distribution having been generated. In this example embodiment, as shown in FIG. 5, the traffic data prediction unit 14 generates the allowable range of a packet frequency, the allowable range of time intervals from the preceding and following packets and the probability of generation of a packet, as the allowable range data M1.

An example of generation of the allowable range data M1 will be described with reference to FIG. 9. In the example of FIG. 9, the vicinity of a part indicated by a symbol “?” is a present moment at which monitoring is performed, and traffic data and process data in an immediately preceding range R immediately before the present moment are used as data for generating the allowable range data M1. At this time, referring to the model M and the data in the immediately preceding range R, first, a control packet 1 is output at constant intervals, and a control packet 2 is also output at constant intervals slightly later than the control packet 1. Moreover, a monitoring packet is not output when the temperature is varying, and is output when the temperature is constant. Besides, when the control packet 1 is frequently output, the air-conditioning operation rate is maintained at a high value, and the air temperature fluctuates greatly.

In consideration of the model M and the traffic data and process data of the immediately preceding range R as described above, the allowable range of a time interval of the control packets 1 of the traffic data, that is, the allowable range of a probability that the value of a measured time interval appears is generated in an example of FIG. 9 (1). For example, the allowable range data M1 is generated in which the probability of appearance is higher as the time interval is closer to five seconds, the probability of appearance is lower as the time interval is farther from five seconds, and a probability lower than a predetermined value is out of the allowable range. As the allowable range of the time interval of the control packets 1, the allowable range of a time interval from other different data may be generated. For example, the allowable range of a time interval from appearance of the previous control packet 2 to the appearance of the control packet 1 may be generated. In this case, as an example, the allowable range data M1 is generated in which the probability of appearance is higher as the time interval is closer to 4.5 seconds, the probability of appearance is lower as the time interval is farther from 4.5 seconds, and a probability lower than a predetermined value is out of the allowable range. Moreover, in an example of FIG. 9 (2), the allowable range of the probability of appearance of a monitoring packet of traffic data is generated. For example, the allowable range data M1 is generated in which the probability of appearance lower than a predetermined value is out of the allowable range.

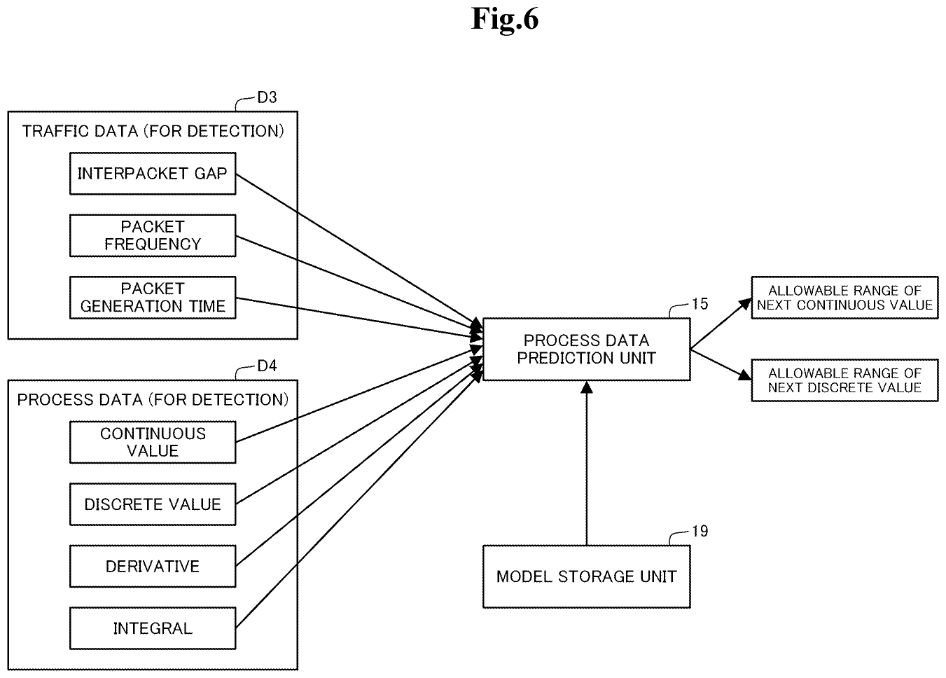

Further, to be specific, the process data prediction unit 15 first retrieves the model M from the model storage unit 19 as shown in the left view of FIG. 2 and FIG. 6 (step S11 of FIG. 12). In addition to this, the process data prediction unit 15 inputs the process data D4 for detection stored in the data storage unit 18 into the model. At this time, the process data prediction unit 15 inputs, as the process data D4 for detection, data measured in a predetermined range time immediately before the present moment (a predetermined moment) at which the target system 20 is monitored (see reference symbol R of FIG. 9) from among data measured prior to the present moment (step S12 of FIG. 12). For example, the process data prediction unit 15 inputs the continuous value, discrete value, derivative, and integral of every kind of physical quantity as the process data D4.

Then, as with the traffic data prediction unit 14 described above, the process data prediction unit 15 generates the allowable range data M1 representing the allowable range that each value such as the continuous value, discrete value, derivative, or integral of every kind of measurement value can take, based on the model M and the process data D4 for detection, as shown by an arrow Y2 and an arrow Y3 of FIG. 7 (step S13 of FIG. 12). The process data prediction unit 15 may also input, in addition to the process data D4 for detection, the traffic data D3 for detection immediately before the present moment into the model and generate the allowable range data M1.

Then, in consideration of the model M and the process data of the immediately precedent range R as described above, the process data prediction unit 15 generates the allowable range of the value of air temperature of process data, that is, the allowable range of the probability of appearance of a measured air temperature value as in an example of FIG. 9 (3). For example, the process data prediction unit 15 generates the allowable range data M1 in which when air temperature is expected to rise, a case where air temperature rises within a predetermined range is highly probable, a case where air temperature does not rise is little probable, and a probability lower than a predetermined value is out of the allowable range.

As shown in FIG. 2, the traffic data monitoring unit 16 and the process data monitoring unit 17 (a detection unit) acquire data at the present moment measured from the target system 20 by the data measurement unit 11. Then, as shown by an arrow 4 of FIG. 7, the traffic data monitoring unit 16 and the process data monitoring unit 17 check whether or not the data D at the present moment is within the allowable range in the allowable range data M1 generated as described above (step S14 of FIG. 12), and detects the state of the target system. At this time, in a case where the data measured at the present moment is within the allowable range data M1 (Yes at step S14 of FIG. 12), the traffic data monitoring unit 16 and the process data monitoring unit 17 detect that the state of the target system 20 is normal and keep monitoring. On the other hand, in a case where the data measured at the present moment is out of the allowable range data M1 (No at step S14 of FIG. 12), the traffic data monitoring unit 16 and the process data monitoring unit 17 detect that the measured data is anomalous. Then, the traffic data monitoring unit 16 and the process data monitoring unit 17 detect the state of the target system by using the detection result (step S15 of FIG. 12). For example, the traffic data monitoring unit 16 and the process data monitoring unit 17 detect that the state of the target system 20 is anomalous in a case where even one of the measured data at the present moment is anomalous. However, the traffic data monitoring unit 16 and the process data monitoring unit 17 may detect the state of the target system 20 by any method. For example, in a case where the number of data detected as anomalous exceeds a plurality of threshold values having been set, the traffic data monitoring unit 16 and the process data monitoring unit 17 may detect an anomaly in the target system 20.

Further, the traffic data monitoring unit 16 and the process data monitoring unit 17 may execute a preset process such as notifying the outside when detecting an anomaly in the target system 20 as described above. Notifying the outside includes various information relating to the target system. For example, notifying the outside includes information relating to the state of the target system, information of processing to be executed on the state of the target system, or the like. By notifying the outside, a person who monitors the target system can appropriately execute processing in accordance with the notification.

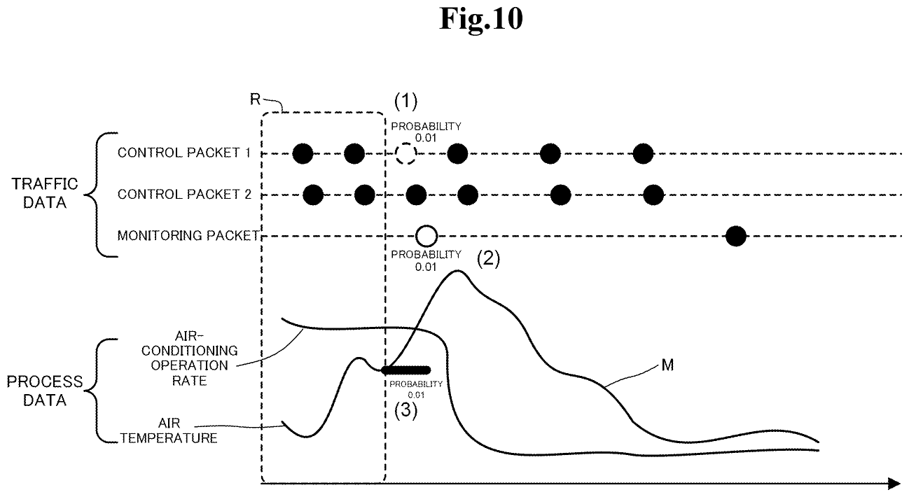

To be specific, the traffic data monitoring unit 16 acquires traffic data at the present moment at which the target system 20 is monitored, and detects whether the traffic data is normal or anomalous with reference to the allowable range data M1. In the example of FIG. 9 (1), the traffic data monitoring unit 16 checks whether the time interval of the control packets 1 that are traffic data is within the allowable range set in the allowable range data M1, that is, whether the value of a measured time interval is within the allowable range of a probability of appearance. At this time, as shown in FIG. 10 (1), in a case where the control packet 1 does not appear for a longer time than five seconds that is the highest appearance probability, the appearance probability becomes 0.01, which is out of the allowable range. Moreover, in the example of FIG. 9 (2), the traffic data monitoring unit 16 checks whether the appearance time of a monitoring packet that is traffic data is within the allowable range set in the allowable range data M1, that is, whether the probability of a measured appearance time is within the allowable range. At this time, as shown in FIG. 10 (2), in a case where the appearance time of the monitoring packet is a time of low probability, the appearance probability becomes 0.01, which is out of the allowable range.

Further, to be specific, the process data monitoring unit 17 acquires process data at the present moment at which the target system 20 is monitored, and detects whether the process data is normal or anomalous with reference to the allowable range data M1. In the example of FIG. 9 (3), the process data monitoring unit 17 checks whether the continuous value of air temperature that is process data is within the allowable range set in the allowable range data M1, that is, whether a probability that the value of air temperature appears is within the allowable range. At this time, as shown in FIG. 10 (3), in a case where the appearance probability of the value of air temperature value is not a temperature rising with reference to the immediately preceding value, but a temperature with no change, the appearance probability becomes 0.01, which is the out of the allowable range.

As described above, according to the present invention, the allowable range of a possible value of data is generated based on a model for predicting the value of data and measured data. Then, the state of the target system 20 is detected in accordance with whether or not data measured from the target system 20 is within the allowable range. Therefore, a criterion for determining the state of the target system 20 is generated in accordance with measured data and the allowable range of the measured data is also set. As a result, it is possible to detect a state at a predetermined moment in accordance with a criterion on which the current state of the target system 20 is reflected, and therefore, it is possible to detect with precision. Moreover, since the allowable range of measured data is set, whether data is allowed or not allowed is not determined simply depending on whether the data agrees or not agree with the model, and therefore, it is possible to prevent detection of an anomalous state from being missed. As a result, it is possible to perform highly precise monitoring according to the state of a system.

In the above description, the present invention is used for, with an information processing system used in a plant as a monitoring target, detecting an anomaly in the system, but a target system to be monitored may be an information processing system used in any field. For example, the present invention may be used for, with a computer system as a monitoring target, measuring data such as a substrate temperature and a memory usage and detecting an anomaly such as a failure or an authorized attack. Moreover, for example, the present invention may be used for, with an information processing system mounted on an autonomous driving vehicle as a monitoring target, measuring data such as a speed and a steering angle and detecting an anomaly such as a failure or an authorized attack.

Further, although a case of detecting whether a target system is in a normal state or an anomalous state is illustrated in the above description, another state of the target system may be detected according to the present invention. For example, by generating an allowable range relating to the high operation state of a target system, it may be detected whether the state of the target system is in a high operation state or a low operation state based on data measured from the target system and an allowable range relating to the high operation state. Likewise, by generating an allowable range relating to every kind of running state of a target system or an allowable range relating to the maintenance state of the target system, every kind of running such as the stopped state of the target system, a maintenance state, or the like, may be detected.

### Second Example Embodiment

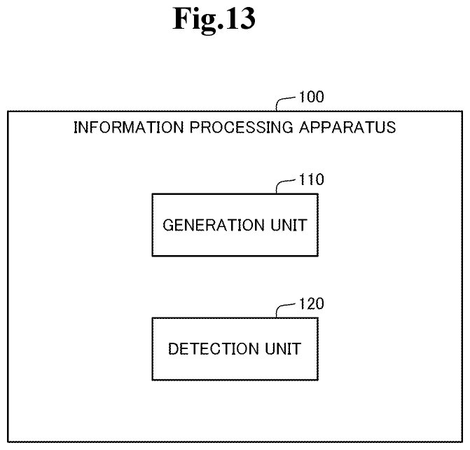

Next, a second example embodiment of the present invention will be described with reference to FIG. 13. FIG. 13 is a block diagram showing a configuration of an information processing apparatus in the second example embodiment. In this example embodiment, the overview of the configuration of the information processing apparatus described in the first example embodiment is illustrated.

As shown in FIG. 13, an information processing apparatus 100 in this example embodiment includes: a generation unit 110 configured to generate an allowable range of a possible value of data measured from a target system based on a model for predicting data to be measured in the target system and data having been measured from the target system; and a detection unit configured to detect a state of the target system based on the data measured from the target system and the allowable range.

The generation unit 110 and the detection unit 120 described above may be structured by execution of a program by an arithmetic logic unit included by the information processing apparatus 100, or may be structured by an electronic circuit.

Then, the information processing apparatus 100 with the above configuration operates to execute processing including: generating an allowable range of a possible value of data measured from a target system based on a model for predicting data to be measured in the target system and data having been measured from the target system; and detecting a state of the target system based on the data measured from the target system and the allowable range.

According to the invention, a model for predicting the value of data and measured data, the allowable range of a possible value of data is generated, and the state of a target system is detected in accordance with whether or not data measured from the target system is within the allowable range. Therefore, a criterion for determining the state of the target system is generated in accordance with the measured data, and the allowable range thereof is also set. As a result, it is possible to detect the state of the target system in accordance with the criterion of a predetermined range on which the current state of the system is reflected, and therefore, it is possible to detect with precision.

### <Supplementary Notes>

The whole or part of the example embodiments disclosed above can be described as the following supplementary notes. The overview of the configurations of the information processing apparatus, the information processing method, and the program according to the present invention will be described below. However, the present invention is not limited to the following configurations.

### (Supplementary Note 1)

An information processing apparatus comprising:

a generation unit configured to generate an allowable range of a possible value of data measured from a target system based on a model for predicting the data measured in the target system and the data having been measured from the target system; and

a detection unit configured to detect a state of the target system based on the data measured from the target system and the allowable range.

### (Supplementary Note 2)

The information processing apparatus according to Supplementary Note 1, wherein:

the generation unit is configured to generate the allowable range based on the model and the data having been measured at least prior to a predetermined moment from the target system; and

the detection unit is configured to detect the state of the target system based on the data measured at the predetermined moment from the target system and the allowable range.

### (Supplementary Note 3)

The information processing apparatus according to Supplementary Note 2, wherein the generation unit is configured to generate the allowable range based on the model and the data having been measured at least immediately before the predetermined moment from the target system.

### (Supplementary Note 4)

The information processing apparatus according to any of Supplementary Notes 1 to 3, wherein the generation unit is configured to generate, as the allowable range, a predictive distribution of the possible value of the data measured from the target system.

### (Supplementary Note 5)

The information processing apparatus according to any of Supplementary Notes 1 to 4, wherein the generation unit is configured to generate, as the allowable range, a probability distribution of the possible value of the data measured from the target system.

### (Supplementary Note 6)

The information processing apparatus according to any of Supplementary Notes 1 to 5, wherein:

the data measured in the target system includes traffic data that is packet data and process data representing a physical quantity; and

the generation unit is configured to generate an allowable range of a possible value of the traffic data based on a model for predicting the traffic data, the traffic data having been measured from the target system, and the process data having been measured from the target system.

### (Supplementary Note 7)

The information processing apparatus according to any of Supplementary Notes 1 to 5, wherein:

the data measured in the target system includes traffic data that is packet data and process data representing a physical quantity; and

the generation unit is configured to generate an allowable range of a possible value of the traffic data based on a model for predicting the traffic data and at least the traffic data having been measured from the target system, and generate an allowable range of a possible value of the process data based on a model for predicting the process data and at least the process data having been measured from the target system.

### (Supplementary Note 8)

The information processing apparatus according to Supplementary Note 7, wherein the generation unit is configured to generate the allowable range of the possible value of the traffic data based on the model for predicting the traffic data, the traffic data having been measured from the target system, and the process data having been measured from the target system.

### (Supplementary Note 9)

The information processing apparatus according to Supplementary Note 7 or 8, wherein the generation unit is configured to generate the allowable range of the possible value of the process data based on the model for predicting the process data, the traffic data having been measured from the target system, and the process data having been measured from the target system.

### (Supplementary Note 10)

The information processing apparatus according to any of Supplementary Notes 1 to 9, comprising a model generation unit configured to generate the model from the data having been measured previously from the target system.

### (Supplementary Note 11)

A computer program comprising instructions for causing an information processing apparatus to realize:

a generation unit configured to generate an allowable range of a possible value of data measured from a target system based on a model for predicting the data measured in the target system and the data having been measured from the target system; and

a detection unit configured to detect a state of the target system based on the data measured from the target system and the allowable range.

### (Supplementary Note 12)

An information processing method comprising:

generating an allowable range of a possible value of data measured from a target system based on a model for predicting the data measured in the target system and the data having been measured from the target system; and

detecting a state of the target system based on the data measured from the target system and the allowable range.

### (Supplementary Note 13)

The information processing method according to Supplementary Note 12, wherein:

the allowable range is generated based on the model and the data having been measured at least prior to a predetermined moment from the target system; and

the state of the target system is detected based on the data measured at the predetermined moment from the target system and the allowable range.

### (Supplementary Note 14)

The information processing method according to Supplementary Note 13, wherein the allowable range is generated based on the model and the data having been measured at least immediately before the predetermined moment from the target system.

### (Supplementary Note 15)

The information processing method according to any of Supplementary Notes 12 to 14, wherein, a predictive distribution of the possible value of the data measured from the target system is generated as the allowable range.

### (Supplementary Note 16)

The information processing method according to any of Supplementary Notes 12 to 15, wherein, a probability distribution of the possible value of the data measured from the target system is generated as the allowable range.

### (Supplementary Note 17)

The information processing method according to any of Supplementary Notes 12 to 16, wherein:

the data measured in the target system includes traffic data that is packet data and process data representing a physical quantity; and

an allowable range of a possible value of the traffic data is generated based on a model for predicting the traffic data, the traffic data having been measured from the target system, and the process data having been measured from the target system.

### (Supplementary Note 18)

The information processing method according to any of Supplementary Notes 12 to 16, wherein:

the data measured in the target system includes traffic data that is packet data and process data representing a physical quantity; and

an allowable range of a possible value of the traffic data is generated based on a model for predicting the traffic data and at least the traffic data having been measured from the target system, and an allowable range of a possible value of the process data is generated based on a model for predicting the process data and at least the process data having been measured from the target system.

### (Supplementary Note 19)

The information processing method according to Supplementary Note 18, wherein the allowable range of the possible value of the traffic data is generated based on the model for predicting the traffic data, the traffic data having been measured from the target system, and the process data having been measured from the target system.

### (Supplementary Note 20)

The information processing method according to Supplementary Note 18 or 19, wherein the allowable range of the possible value of the process data is generated based on the model for predicting the process data, the traffic data having been measured from the target system, and the process data having been measured from the target system.

### (Supplementary Note 21)

The information processing method according to any of Supplementary Notes 12 to 20, comprising generating the model from the data having been measured previously from the target system.

The program described above is can be stored by using various types of non-transitory computer-readable mediums and supplied to a computer. The non-transitory computer-readable mediums include various types of tangible storage mediums. Examples of the non-transitory computer-readable mediums include a magnetic recording medium (for example, a flexible disk, a magnetic tape, a hard disk drive), a magnetooptical recording medium (for example, a magnetooptical disk), a CD-ROM (Read Only Memory), a CD-R, a CD-R/W, and a semiconductor memory (for example, a mask ROM, a PROM (Programmable ROM), an EPROM (Erasable PROM), a flash ROM, a RAM (Random Access Memory). The program may be supplied to a computer by various types of transitory computer-readable mediums. Examples of the transitory computer-readable mediums include electric signals, optical signals, and electromagnetic waves. The transitory computer-readable medium can supply the program to a computer via a wired communication channel such as an electric wire or an optical fiber or via a wireless communication channel.

Although the present invention has been described above with reference to the example embodiments, the present invention is not limited to the example embodiments. The configurations and details of the present invention can be changed in various manners that can be understood by one skilled in the art within the scope of the present invention.

### DESCRIPTION OF NUMERALS

10 information processing apparatus
11 data measurement unit
12 traffic data learning unit
13 process data learning unit
14 traffic data prediction unit
15 process data prediction unit
16 traffic data monitoring unit
17 process data monitoring unit
18 data storage unit
19 model storage unit
100 information processing apparatus
110 generation unit
120 detection unit
D1 traffic data (for learning)
D2 process data (for learning)
D3 traffic data (for detecting)
D4 process data (for detecting)
M model
M1 allowable range data

What is claimed is:

1. An information processing apparatus comprising:
a memory in which instructions are stored; and
at least one processor configured to execute the instructions, wherein the instructions comprises:
generating an allowable range of a possible value of data measured from a target system based on a model for predicting the data measured in the target system and the data having been measured from the target system; and
detecting a state of the target system based on the data measured from the target system and the allowable range.

2. The information processing apparatus according to claim 1, wherein the instructions comprises:
generating the allowable range based on the model and the data having been measured at least prior to a predetermined moment from the target system; and
detecting the state of the target system based on the data measured at the predetermined moment from the target system and the allowable range.

3. The information processing apparatus according to claim 2, wherein the instructions comprises generating the allowable range based on the model and the data having been measured at least immediately before the predetermined moment from the target system.

4. The information processing apparatus according to claim 1, wherein the instructions comprises generating, as the allowable range, a predictive distribution of the possible value of the data measured from the target system.

5. The information processing apparatus according to claim 1, wherein the instructions comprises generating, as the allowable range, a probability distribution of the possible value of the data measured from the target system.

6. The information processing apparatus according to claim 1, wherein:
the data measured in the target system includes traffic data that is packet data and process data representing a physical quantity; and
the instructions comprises generating an allowable range of a possible value of the traffic data based on a model for predicting the traffic data, the traffic data having been measured from the target system, and the process data having been measured from the target system.

7. The information processing apparatus according to claim 1, wherein:
the data measured in the target system includes traffic data that is packet data and process data representing a physical quantity; and
the instructions comprises generating an allowable range of a possible value of the traffic data based on a model for predicting the traffic data and at least the traffic data having been measured from the target system, and generating an allowable range of a possible value of the process data based on a model for predicting the process data and at least the process data having been measured from the target system.

8. The information processing apparatus according to claim 7, wherein the instructions comprises generating the allowable range of the possible value of the traffic data based on the model for predicting the traffic data, the traffic data having been measured from the target system, and the process data having been measured from the target system.

9. The information processing apparatus according to claim 7, wherein the instructions comprises generating the allowable range of the possible value of the process data based on the model for predicting the process data, the traffic data having been measured from the target system, and the process data having been measured from the target system.

10. The information processing apparatus according to claim 1, wherein the instructions comprises generating the model from the data having been measured previously from the target system.

11. A non-transitory computer-readable storage medium in which a computer program is stored, the computer program comprising instructions for causing an information processing apparatus to execute processing of:
generating an allowable range of a possible value of data measured from a target system based on a model for predicting the data measured in the target system and the data having been measured from the target system; and
detecting a state of the target system based on the data measured from the target system and the allowable range.

12. An information processing method comprising:
generating an allowable range of a possible value of data measured from a target system based on a model for predicting the data measured in the target system and the data having been measured from the target system; and
detecting a state of the target system based on the data measured from the target system and the allowable range.

13. The information processing method according to claim 12, wherein:
the allowable range is generated based on the model and the data having been measured at least prior to a predetermined moment from the target system; and
the state of the target system is detected based on the data measured at the predetermined moment from the target system and the allowable range.

14. The information processing method according to claim 13, wherein the allowable range is generated based on the model and the data having been measured at least immediately before the predetermined moment from the target system.

15. The information processing method according to claim 12, wherein, a predictive distribution of the possible value of the data measured from the target system is generated as the allowable range.

16. The information processing method according to claim 12, wherein, a probability distribution of the possible value of the data measured from the target system is generated as the allowable range.

17. The information processing method according to claim 12, wherein:
the data measured in the target system includes traffic data that is packet data and process data representing a physical quantity; and
an allowable range of a possible value of the traffic data is generated based on a model for predicting the traffic data, the traffic data having been measured from the target system, and the process data having been measured from the target system.

18. The information processing method according to claim 12, wherein:
the data measured in the target system includes traffic data that is packet data and process data representing a physical quantity; and
an allowable range of a possible value of the traffic data is generated based on a model for predicting the traffic data and at least the traffic data having been measured from the target system, and an allowable range of a possible value of the process data is generated based on a model for predicting the process data and at least the process data having been measured from the target system.

19. The information processing method according to claim 18, wherein the allowable range of the possible value of the traffic data is generated based on the model for predicting the traffic data, the traffic data having been measured from the target system, and the process data having been measured from the target system.

20. The information processing method according to claim 18, wherein the allowable range of the possible value of the process data is generated based on the model for predicting the process data, the traffic data having been measured from the target system, and the process data having been measured from the target system.

21. (canceled)
